(19) United States
(12) Patent Application Publication
(10) Pub. No.: US 2008/0220304 A1
(43) Pub. Date: Sep. 11, 2008

(54) VENTING APPARATUS AND SYSTEM

(75) Inventors: Michael Aaron Spaner, Deep River, CT (US); Dean Edwin Halter, West Hartford, CT (US); Iris Liane Shiroma, Rocky Hill, CT (US)

Correspondence Address: CANTOR COLBURN, LLP - PROTON, 20 Church Street, 22nd Floor, Hartford, CT, 06103, US

(73) Assignee: PROTON ENERGY SYSTEMS, INC., WALLINGFORD, CT (US)

(21) Appl. No.: 11/683,565

(22) Filed: Mar. 8, 2007

(51) Int. Cl. H01M 8/04

(52) U.S. Cl. 429/25; 429/34

(57) ABSTRACT

A hydrogen separator apparatus for an electrochemical cell is disclosed. The apparatus includes a separation chamber in fluid communication with the electrochemical cell, a product conduit in fluid communication with the separation chamber, and a controllable purge path in fluid communication with the separation chamber. The controllable purge path is disposed at a bottom of the separation chamber such that in response to normal operation of the cell, the controllable purge path is exposed to liquid water and only during start up and shut down of the cell is the controllable purge path exposed to hydrogen gas. The controllable purge path is responsive to a plurality of conditions corresponding to operation of the electrochemical cell.

### BACKGROUND OF THE INVENTION

The present disclosure relates generally to electrochemical cells, and particularly to venting gasses that result from operation of electrochemical cells.

Electrochemical cells are energy conversion devices, usually classified as either electrolysis cells or fuel cells. A proton exchange membrane electrolysis cell can function as a hydrogen generator by electrolytically decomposing water to produce hydrogen and oxygen gas, and can function as a fuel cell by electrochemically reacting hydrogen with oxygen to generate electricity. Referring to FIG. 1, which is a partial section of a typical anode feed electrolysis cell 100, process water 102 is fed into cell 100 on the side of an oxygen electrode (anode) 116 to form oxygen gas 104, electrons, and hydrogen ions (protons) 106. The reaction is facilitated by the positive terminal of a power source 120 electrically connected to anode 116 and the negative terminal of power source 120 connected to a hydrogen electrode (cathode) 114. The oxygen gas 104 and a portion of the process water 108 exit the cell 100, while protons 106 and water 110 migrate across a proton exchange membrane 118 to cathode 114 where hydrogen gas 112 is produced.

Another typical water electrolysis cell using the same configuration as is shown in FIG. 1 is a cathode feed cell, wherein process water is fed on the side of the hydrogen electrode. A portion of the water migrates from the cathode across the membrane to the anode where hydrogen ions and oxygen gas are formed due to the reaction facilitated by connection with a power source across the anode and cathode. A portion of the process water exits the cell at the cathode side without passing through the membrane.

A typical fuel cell uses the same general configuration as is shown in FIG. 1. Hydrogen, from hydrogen gas, methanol, or other hydrogen source, is introduced to the hydrogen electrode (the anode in fuel cells), while oxygen, or an oxygen-containing gas such as air, is introduced to the oxygen electrode (the cathode in fuel cells). Water can also be introduced with the feed gas. Hydrogen electrochemically reacts at the anode to produce protons and electrons, wherein the electrons flow from the anode through an electrically connected external load, and the protons migrate through the membrane to the cathode. At the cathode, the protons and electrons react with oxygen to form water, which additionally includes any feed water that is dragged through the membrane to the cathode. The electrical potential across the anode and the cathode can be exploited to power an external load.

In other embodiments, one or more electrochemical cells can be used within a system to both electrolyze water to produce hydrogen and oxygen, and to produce electricity by converting hydrogen and oxygen back into water as needed. Such systems are commonly referred to as regenerative fuel cell systems.

Electrochemical cell systems typically include a number of individual cells arranged in a stack, with the working fluids directed through the cells via input and output conduits or ports formed within the stack structure. The cells within the stack are sequentially arranged, each including a cathode, a proton exchange membrane, and an anode. The cathode and anode may be separate layers or may be integrally arranged with the membrane. Each cathode/membrane/anode assembly (hereinafter “membrane-electrode-assembly”, or “MEA”) typically has a first flow field in fluid communication with the cathode and a second flow field in fluid communication with the anode. The MEA may furthermore be supported on both sides by screen packs or bipolar plates that are disposed within, or that alternatively define, the flow fields. Screen packs or bipolar plates may facilitate fluid movement to and from the MEA, membrane hydration, and may also provide mechanical support for the MEA.

In order to maintain intimate contact between cell components under a variety of operational conditions and over long time periods, uniform compression may be applied to the cell components. Pressure pads or other compression means are often employed to provide even compressive force from within the electrochemical cell.

As a result of normal operating conditions of the anode feed electrolysis cell 100, at least one controllable gas vent path is provided to vent high pressure hydrogen from a high pressure separator in response to specific operating conditions, such as a start-up or shut-down of the cell 100, for example. The controllable gas vent path includes a controllable valve that is responsive to the cell 100 operating conditions. Controllable valves that are exposed to hydrogen gas for extended periods of time incorporate a material to resist a condition known as hydrogen embrittlement that results from such exposure in standard valve materials. Valves adapted for extended exposure to hydrogen gas represent a significant cost. Additionally, such valves represent components within an electrochemical cell system that may require service and maintenance, thereby reducing an overall system reliability. Accordingly, a need exists for an improved gas venting arrangement that overcomes these drawbacks.

### BRIEF DESCRIPTION OF THE INVENTION

An embodiment of the invention includes a hydrogen separator apparatus for an electrochemical cell. The apparatus includes a separation chamber in fluid communication with the electrochemical cell, a product conduit in fluid communication with the separation chamber, and a controllable purge path in fluid communication with the separation chamber. The controllable purge path is disposed at a bottom of the separation chamber such that in response to normal operation of the cell, the controllable purge path is exposed to liquid water and only during start up and shut down of the cell is the controllable purge path exposed to hydrogen gas. The controllable purge path is responsive to a plurality of conditions corresponding to operation of the electrochemical cell.

Another embodiment of the invention includes an electrochemical cell system. The electrochemical cell system includes an electrochemical cell, a separation chamber in fluid communication with the electrochemical cell, a product conduit in fluid communication with the separation chamber, and a controllable purge path in fluid communication with the separation chamber. The controllable purge path is disposed at a bottom of the separation chamber such that in response to normal operation of the electrochemical cell, the controllable purge path is exposed to liquid water and only during start up and shut down of the electrochemical cell is the controllable purge path exposed to hydrogen gas. The controllable purge path is responsive to a plurality of conditions corresponding to operation of the electrochemical cell.

These and other advantages and features will be more readily understood from the following detailed description of preferred embodiments of the invention that is provided in connection with the accompanying drawings.

### BRIEF DESCRIPTION OF THE DRAWINGS

Referring to the exemplary drawings wherein like elements are numbered alike in the accompanying Figures:

FIG. 1 depicts a schematic diagram of a partial electrochemical cell in accordance with embodiments of the invention;

FIG. 2 depicts a schematic diagram of an electrochemical cell system for use in embodiments of the invention; and

FIG. 3 depicts a schematic diagram of an electrochemical cell system in accordance with embodiments of the invention.

### DETAILED DESCRIPTION OF THE INVENTION

An embodiment of the invention provides a high pressure hydrogen separator including a single controllable valve that is absent an extended time exposure to hydrogen gas. As used herein, the term “high pressure” shall refer to a pressure that is greater than 100 pounds per square inch (psi).

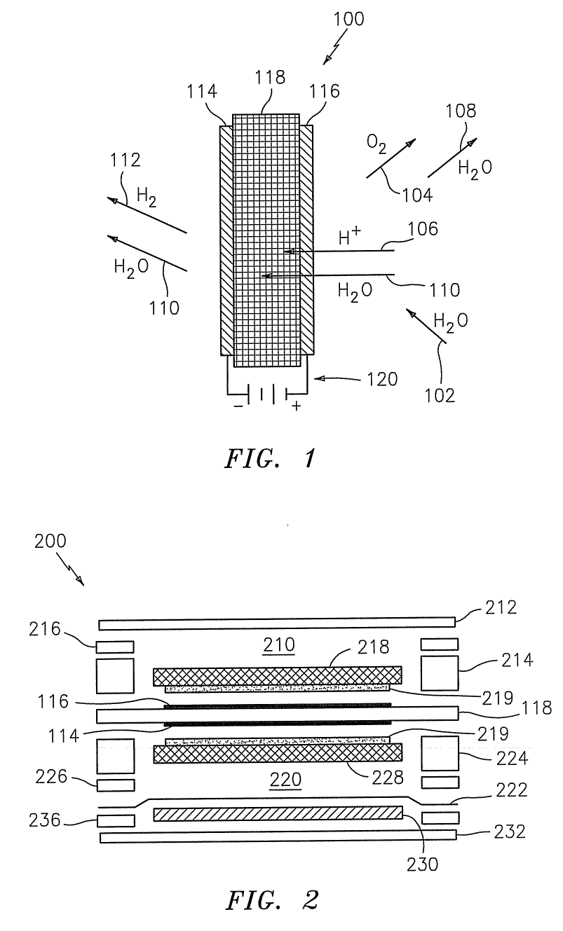

Referring to FIG. 2, an electrochemical cell 200 that may be suitable for operation as an anode feed electrolysis cell, cathode feed electrolysis cell, fuel cell, or regenerative fuel cell, is depicted schematically in an exploded cross section view. Thus, while the discussion below may be directed to an anode feed electrolysis cell, cathode feed electrolysis cells, fuel cells, and regenerative fuel cells are also contemplated. Cell 200 is typically one of a plurality of cells employed in a cell stack as part of an electrochemical cell system. When cell 200 is used as an electrolysis cell, voltage inputs are generally between about 1.48 volts and about 3.0 volts, at current densities between about 50 A/ft2 (amperes per square foot) and about 4,000 A/ft2. When used as a fuel cell, voltage outputs range between about 0.4 volts and about 1 volt, at current densities between about 0.1 A/ft2 and about 10,000 A/ft2. The number of cells within the stack, and the dimensions of the individual cells is scalable to the cell power output and/or gas output requirements. Accordingly, application of electrochemical cell 200 may involve a plurality of cells 200 arranged electrically either in series or parallel depending on the application. Cells 200 may be operated at a variety of pressures, such as up to or exceeding 50 psi (pounds-per-square-inch), up to or exceeding about 100 psi, up to or exceeding about 500 psi, up to or exceeding about 2500 psi, or even up to or exceeding about 10,000 psi, for example.

In an embodiment, cell 200 includes a membrane 118 having a first electrode (e.g., an anode) 116 and a second electrode (e.g., a cathode) 114 disposed on opposite sides thereof. Flow fields 210, 220, which are in fluid communication with electrodes 116 and 114, respectively, are defined generally by the regions proximate to, and bounded on at least one side by, each electrode 116 and 114 respectively. A flow field member (also herein referred to as a screen pack) 228 may be disposed within flow field 220 between electrode 114 and, optionally, a pressure pad separator plate 222. A pressure pad 230 is typically disposed between pressure pad separator plate 222 and a cell separator plate 232. Cell separator plate 232 is disposed adjacent to pressure pad 230. A frame 224, generally surrounding flow field 220 and an optional gasket 226, is disposed between frame 224 and pressure pad separator plate 222 generally for enhancing the seal within the reaction chamber defined on one side of cell system 200 by frame 224, pressure pad separator plate 222 and electrode 114. Gasket 236 may be disposed between pressure pad separator plate 222 and cell separator plate 232 enclosing pressure pad 230.

Another screen pack 218 may be disposed in flow field 210. Optionally, screen packs 218, 228 may include a porous plate 219 as depicted. The porous plate 219 shall preferably be of conductive material, and may be included to provide additional mechanical support to the electrodes 116, 114. A frame 214 generally surrounds screen pack 218. A cell separator plate 212 is disposed adjacent screen pack 218 opposite oxygen electrode 116, and a gasket 216 may be disposed between frame 214 and cell separator plate 212, generally for enhancing the seal within the reaction chamber defined by frame 214, cell separator plate 212 and the oxygen side of membrane 118. The cell components, particularly cell separator plates 212, 232, frames 214, 224, and gaskets 216, 226, and 236 are formed with the suitable manifolds or other conduits as is conventional.

In an embodiment, membrane 118 comprises electrolytes that are preferably solids or gels under the operating conditions of the electrochemical cell. Useful materials include proton conducting ionomers and ion exchange resins. Useful proton conducting ionomers include complexes comprising an alkali metal salt, an alkali earth metal salt, a protonic acid, or a protonic acid salt. Useful complex-forming reagents include alkali metal salts, alkaline metal earth salts, and protonic acids and protonic acid salts. Counter-ions useful in the above salts include halogen ion, perchloric ion, thiocyanate ion, trifluoromethane sulfonic ion, borofluoric ion, and the like. Representative examples of such salts include, but are not limited to, lithium fluoride, sodium iodide, lithium iodide, lithium perchlorate, sodium thiocyanate, lithium trifluoromethane sulfonate, lithium borofluoride, lithium hexafluorophosphate, phosphoric acid, sulfuric acid, trifluoromethane sulfonic acid, and the like. The alkali metal salt, alkali earth metal salt, protonic acid, or protonic acid salt is complexed with one or more polar polymers such as a polyether, polyester, or polyimide, or with a network or cross-linked polymer containing the above polar polymer as a segment. Useful polyethers include polyoxyalkylenes, such as polyethylene glycol, polyethylene glycol monoether, and polyethylene glycol diether; copolymers of at least one of these polyethers, such as poly(oxyethylene-co-oxypropylene)glycol, poly(oxyethylene-co-oxypropylene)glycol monoether, and poly(oxyethylene-co-oxypropylene)glycol diether; condensation products of ethylenediamine with the above polyoxyalkylenes; and esters, such as phosphoric acid esters, aliphatic carboxylic acid esters or aromatic carboxylic acid esters of the above polyoxyalkylenes. Copolymers of, e.g., polyethylene glycol with diallylsiloxanes, maleic anhydride, or polyethylene glycol monoethyl ether with methacrylic acid are known in the art to exhibit sufficient ionic conductivity to be useful.

Ion-exchange resins useful as proton conducting materials include hydrocarbon- and fluorocarbon-type resins. Hydrocarbon-type ion-exchange resins include phenolic resins, condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation, or are imbued with anion-exchange ability by chloromethylation followed by conversion to the corresponding quaternary amine.

Fluorocarbon-type ion-exchange resins may include hydrates of tetrafluoroethylene-perfluorosulfonyl ethoxyvinyl ether or tetrafluoroethylene-hydroxylated (perfluoro vinyl ether) copolymers. When oxidation and/or acid resistance is desirable, for instance, at the cathode of a fuel cell, fluorocarbon-type resins having sulfonic, carboxylic and/or phosphoric acid functionality are preferred. Fluorocarbon-type resins typically exhibit excellent resistance to oxidation by halogen, strong acids and bases. One family of fluorocarbon-type resins having sulfonic acid group functionality is NAFION™ resins (commercially available from E. I. du Pont de Nemours and Company, Wilmington, Del.).

Electrodes 116 and 114 may comprise a catalyst suitable for performing the needed electrochemical reaction (i.e., electrolyzing water and producing hydrogen). Suitable catalyst include, but are not limited to, materials comprising platinum, palladium, rhodium, carbon, gold, tantalum, tungsten, ruthenium, iridium, osmium, alloys thereof, and the like. Electrodes 116 and 114 may be formed on membrane 118, or may be layered adjacent to, but in contact with, membrane 118.

Screen packs 218, 228 support membrane 118, allow the passage of system fluids, and preferably are electrically conductive. The screen packs 218, 228 may include one or more layers of perforated sheets or a woven mesh formed from metal or strands.

Pressure pad 230 provides even compression between cell components, is electrically conductive, and therefore generally comprises a resilient member, preferably an elastomeric material, together with a conductive material. Pressure pad 230 is capable of maintaining intimate contact to cell components at cell pressures up to or exceeding about 100 psi, preferably about 500 psi, more preferably about 2,500 psi, or even more preferably about 10,000 psi. The pressure pads can thus be introduced into a high-pressure electrochemical cell environment. The foregoing is intended for illustration, and not limitation

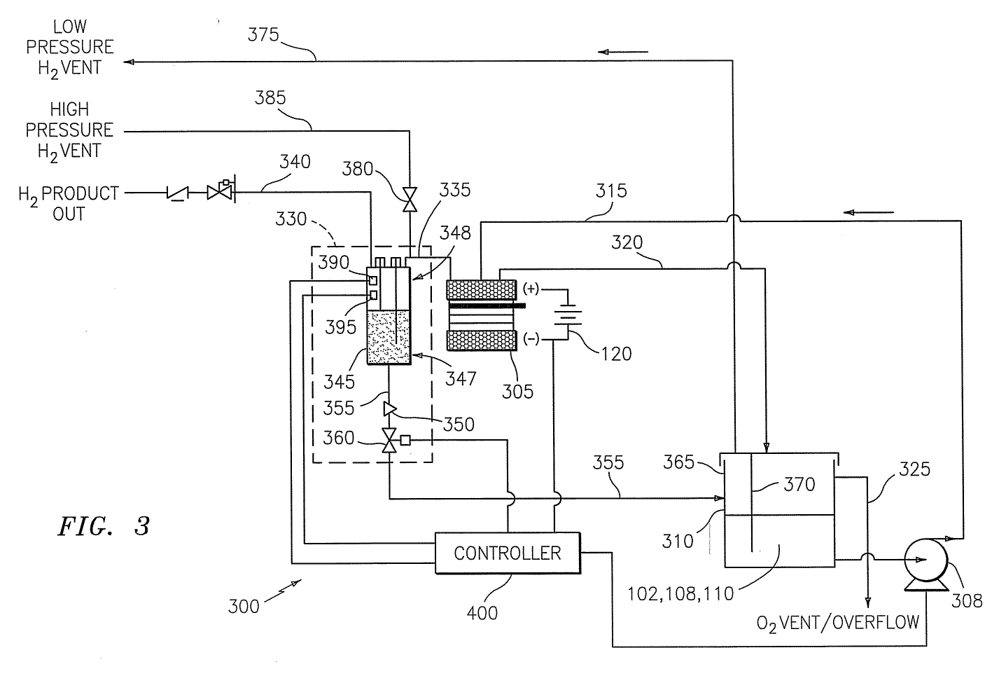

Referring now to FIG. 3 in conjunction with FIG. 1, an embodiment of an electrochemical cell system 300 including an electrochemical cell 305, such as an electrolysis cell 305, is depicted. The electrolysis cell 305 utilizes the power source 120 and process water 102 stored within a storage container 310 to produce hydrogen gas 112. The process water 102 is supplied to the cell 305 via a pump 308 through a supply conduit 315, such as a pipe, tubing, or other suitable means to transport fluid. Oxygen 104 and water 108 are returned to the storage container 310 via a return conduit 320, where at least some water 108 will condense and collect in the bottom of the storage container 310 and at least some oxygen 104 will be vented via vent conduit 325. Water 110 and hydrogen 112 produced by the cell 305 are provided to a high pressure separator module 330 (also herein referred to as a “module”) via a feed conduit 335 in fluid communication between the cell 305 and the module 330. The module 330 is adapted to separate gaseous hydrogen 112 from water 110 that may be in at least one of the vapor and liquid phases, and are produced and transported together, respectively, by the cell 305 and the feed conduit 335.

The module 330 includes a chamber 345 (also herein referred to as a separation chamber) to accumulate gaseous hydrogen 112 and liquid water 110 as provided by operation of the cell 305. The chamber 345 is in fluid communication with the electrochemical cell 305 via the feed conduit 335. Hydrogen 112, with at least some of the water 110 separated within the chamber 345, is provided for at least one of further processing, storage, and use via a product conduit 340 in fluid communication with the chamber 345. Liquid water 110 and hydrogen gas 112 are separated within the chamber 345 according to a difference in their respective densities. It will be appreciated that liquid water 110, having a greater density than hydrogen gas 112, will accumulate at a bottom 347 (as defined with respect to gravity, that is: having a smallest radial distance to a surface of the Earth) of the chamber 345. Similarly, hydrogen gas 112 will accumulate at a top 348 of the chamber 345.

The module 330 further includes a flow rate control 350, such as an orifice 350 in fluid communication with the chamber 345 via a purge conduit 355. The orifice 350 is in further fluid communication with a controllable valve 360, such as a solenoid valve, that controls a flow of at least one of water 110 and hydrogen 112 to a low pressure separator module 365 via the purge conduit 355. The solenoid valve 360 is strategically configured and disposed for response to a plurality of conditions corresponding to operation of the cell 305, and reduced hydrogen embrittlement, as will be discussed further below. In an alternate embodiment, the solenoid valve 360 may be placed before, or upstream, of the orifice 350. Such placement is contemplated to result in the need for a solenoid valve 360 having a higher pressure capability, which may add expense and operational complexity to the system 300.

The low pressure separator module 365 is in fluid communication with the storage container 310 to provide the water 110 for re-use as process water 102. In an embodiment, the low pressure separator module 365 and the storage container 310 share an external structure and are in fluid communication via an underflow weir 370. The underflow weir 370 allows water 110 from the module 330 to mix with process water 102 and water 108, but prevents a mixing of hydrogen 112 and oxygen 104. Excess hydrogen 112 is vented from the low pressure separator module 365 via a vent 375.

A pressure release 380, such as a relief valve, is in fluid communication with the feed conduit 335 and is directly responsive to a pressure within at least one of the chamber 345, the feed conduit 335, and the cell 305 above a release pressure to open and release any hydrogen 112 and/or water 110 via a vent conduit 385. The relief valve 380 operates directly in response to the pressure within at least one of the chamber 345, the feed conduit 335, and the cell 305, independent of any other condition or control mechanism corresponding to operation of the electrochemical cell 305. In an embodiment, the release pressure is selected to prevent a permanent damage of at least one of the chamber 345, the feed conduit 335, the cell 305, and any components thereof. In an embodiment, the release pressure is approximately 1000 psi. In another embodiment, the release pressure is approximately 1500 psi. In another embodiment, the release pressure is approximately 2650 psi. In another embodiment, the release pressure is approximately 3000 psi. As used herein, the term “approximately” represents a quantity of deviation from the stated value that can be a result of tolerances such as those associated with material properties, manufacturing processes, and design target calculations, for example.

A controller 400 is receptive of a set of signals representative of conditions corresponding to operation of the cell 305. A pressure sensor 390 is in fluid communication with the chamber 345 and generates a signal representative of a pressure within the chamber 345. A level sensor 395 is in fluid communication with the chamber 345 and generates a signal representative of a level, or quantity of water 110 within the chamber 345. The controller 400 in signal communication with the pressure sensor 390, the water level sensor 395, and at least one of the solenoid valve 360, the pump 308, and the power supply 120. The controller 400 is productive of at least one signal to control an operating condition of at least one of the pump 308, the power supply 120, and the solenoid valve 360 to initiate, conclude, or modify operation of the system 300. Examples of conditions corresponding to operation of the cell 305 to which at least one of the solenoid valve 360, the power supply 120 and the pump 308 are responsive include at least one of a level of liquid within the chamber 345, an operating pressure of gas within the chamber 345, an initiation of operation of the cell 305, and a conclusion of operation of the cell 305, as will be described further below.

For example, in conjunction with an initiation of operation of the system 300, it may be desired to effect a purging of the system 300 to increase a likelihood that pure hydrogen 112 is provided to the product conduit 340. Accordingly, during the initiation of operation of the system, the solenoid valve 360 is responsive to the controller 400 to be opened to purge the system 300 and release any hydrogen 112 and water 110 produced by the cell 305 to the low pressure separator module 365 via the purge conduit 355. As another example, in conjunction with a conclusion of operation of the system 300, it may be desired to release any water 110 or hydrogen 112 within the chamber 345 to the low pressure separator module 365 via the purge conduit 355. Accordingly, during the conclusion of operation of the system, the solenoid valve 360 is responsive to the controller 400 to be opened to release any hydrogen 112 and water 110 to the low pressure separator module 365 via the purge conduit 355.

As an additional example, during operation of the cell 300, it may be desired to maintain a range of water 110 levels within the chamber 345. An example of a control method to maintain the range of water 110 levels includes control between a high level and a low level. Accordingly, in response to the water 110 within the chamber 345 reaching the high level of the range of levels, the controller 400 is receptive of a high level signal generated by the water level sensor 395. The controller 400 is responsive to the high level signal to produce an open control signal to which the solenoid valve 360 is responsive to open to drain the water 110 to the low pressure separator module 365. In response to the water 110 within the chamber 345 reaching the low level of the range of levels, the controller 400 is receptive of a low level signal generated by the water level sensor 395. The controller 400 is responsive to the low level signal to produce a close control signal to which the solenoid valve 360 is responsive to close. Various alternate control methods to maintain the range of water 110 levels are contemplated. For example, the range of water 110 levels can be maintained around a setpoint using closed loop control, an analog level signal, and a proportional valve. Another embodiment is contemplated to utilize pulse width modulation. Use of such alternate control methods will minimize system hydrogen pressure fluctuations.

As an additional example, during operation of the system 300, it may be desired to prevent a build up of hydrogen 112 pressure beyond a maximum operating pressure. As an example, the maximum operating pressure is selected to be just slightly below the release pressure described above, such that under contemplated operating conditions, the release pressure is never attained. Accordingly, in response to the hydrogen 112 within the chamber 345 reaching the maximum operating pressure, the controller 400 is receptive of a high pressure signal generated by the pressure sensor 390. The controller 400 is responsive to the high pressure signal to conclude operation of the system 300 and produce the open control signal to which the solenoid valve 360 is responsive to open. As an example, in an embodiment in which the release pressure is 1000 psi, the maximum operating pressure is contemplated to be 900 psi. In another embodiment, in which the release pressure is 1500 psi, the maximum operating pressure is contemplated to be 1400 psi. In another embodiment in which the release pressure is 2650 psi, the maximum operating pressure contemplated to be 2550 psi, and so forth. The foregoing examples are provided for purposes of illustration, not limitation.

In an embodiment, the solenoid valve 360 is a normally open solenoid valve 360. Use of the normally open solenoid valve 360 will result in an automatic opening of the solenoid valve 360 in response to unexpected control events, such as a disruption of the signal communication between the controller 400 and the controllable valve 360, and a loss of control power, for example. Accordingly, in response to unexpected control events, any accumulated gas pressure or fluid, such as hydrogen gas 112 or water 110, within the chamber 345 will be released by the normally open solenoid valve 360 via the purge conduit 355.

In an exemplary embodiment, as shown in FIG. 3, the purge conduit 355, in conjunction with the orifice 350 and the controllable valve 360, represent a single (that is, only one) controllable purge path in fluid communication with, and disposed at the bottom of, the separation chamber 345. The single controllable purge path, utilizing the controllable valve 360, is strategically disposed at the bottom of the separation chamber 345, and is therefore responsive to at least the foregoing plurality of conditions described as corresponding to operation of the cell 305.

An embodiment of the invention is distinguished from other systems that typically utilize more than one controllable valve, with each controllable valve responsive to fewer than all of the foregoing described conditions. One example of such existing typical systems is to have one valve responsive to the range of operating pressures, and another valve responsive to the range of water levels within the chamber 345.

Furthermore, because the solenoid valve 360 is strategically disposed at the bottom 347 of the chamber 345 it will be exposed, for most of the time, during most normal operation of the cell, to the liquid water 110 that will accumulate at the bottom of the chamber 345, rather than hydrogen gas 112, which will accumulate at the top of the chamber 345. It is contemplated that the solenoid valve 360 will be exposed to hydrogen gas 112 only during an initial start-up of the system 300, such as a period of time required for liquid water 110 to begin to accumulate and settle to the bottom of the chamber 345. Stated alternatively, the solenoid valve 360 is absent an extended time exposure to hydrogen gas 112. Accordingly, the solenoid valve 360 will have a significantly reduced likelihood of developing hydrogen embrittlement, and may have a corresponding lower cost than a solenoid valve adapted for use including extended time exposure to hydrogen gas 112. As used herein, the term “disposed at a bottom of the separation chamber” does not necessarily mean on a bottom surface of the chamber, but rather means close enough to the bottom of the chamber so as to perform as disclosed herein.

The orifice 350 controls flow rates of a gas, such as hydrogen 112, a liquid, such as water 110, and a mixture of the liquid and gas from the chamber 345. The flow rates of hydrogen 112 and water 110 are controlled to appropriate rates according to capacities of at least one of the purge conduit 355, the low pressure separator module 365, and the vent 375. Further, the flow rates of hydrogen 112 and water 110 are controlled to release any pressure of the cell 305 to appropriate rates of depressurization to limit stress upon the cell 305 and membrane 118. Accordingly, the orifice 350 shall be sized to provide an appropriate flow rate of: liquid water 110, such as when maintaining the range of water 110 levels within the chamber 345 for example; gaseous hydrogen 112, such as when maintaining the range of hydrogen 112 pressures for example; and a mixture of liquid water 110 and gaseous hydrogen 112, such as when purging the system 300, for example. It is contemplated that use of an orifice having an opening size that can be varied in response to various operating conditions, such as at least one of temperature, pressure, and viscosity of the water 110, hydrogen 112, and water 110 and hydrogen 112 mixture, will be beneficial to maintaining appropriate flow rates.

While an embodiment has been described using the orifice 350 to control flow rates, it will be appreciated that the scope of the invention is not so limited, and that the invention will also apply to modules 330 that control flow rates via other means, such as via a needle valve, and the controllable valve 360, for example.

As disclosed, some embodiments of the invention may include some of the following advantages: an ability to increase an overall reliability of an electrochemical cell by eliminating a gas purge path controllable valve; and an ability to reduce a cost of an electrochemical cell system by eliminating an extended time exposure of a controllable valve to hydrogen gas.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A hydrogen separator apparatus for an electrochemical cell, the apparatus comprising:
a separation chamber in fluid communication with the electrochemical cell;
a product conduit in fluid communication with the separation chamber; and
a controllable purge path in fluid communication with the separation chamber and disposed at a bottom of the separation chamber such that in response to normal operation of the cell, the controllable purge path is exposed to liquid water and only during start up and shut down of the cell is the controllable purge path exposed to hydrogen gas, the controllable purge path responsive to a plurality of conditions corresponding to operation of the electrochemical cell.

2. The apparatus of claim 1, wherein:
the controllable purge path is a single controllable purge path.

3. The apparatus of claim 1, the controllable purge path comprising:
a controllable valve strategically disposed to reduce hydrogen embrittlement thereof.

4. The apparatus of claim 3, wherein:
the controllable valve is a normally open solenoid valve.

5. The apparatus of claim 1, wherein:
the electrochemical cell is an electrolysis cell.

6. The apparatus of claim 1, wherein the plurality of conditions corresponding to operation of the electrochemical cell comprise at least two of:
a level of liquid within the separation chamber;
a maximum operating pressure of gas within the separation chamber;
an initiation of operation of the electrochemical cell; and
a conclusion of operation of the electrochemical cell.

7. The apparatus of claim 1, the controllable purge path comprising:
a flow rate control to control a flow rate therethrough of:
a liquid;
a gas; and
a mixture of the liquid and the gas.

8. An electrochemical cell system comprising:
an electrochemical cell;
a separation chamber in fluid communication with the electrochemical cell;
a product conduit in fluid communication with the separation chamber; and
a controllable purge path in fluid communication with the separation chamber and disposed at a bottom of the separation chamber such that in response to normal operation of the electrochemical cell, the controllable purge path is exposed to liquid water and only during start up and shut down of the electrochemical cell is the controllable purge path exposed to hydrogen gas, the controllable purge path responsive to a plurality of conditions corresponding to operation of the electrochemical cell.

9. The system of claim 8, wherein:
the controllable purge path is a single controllable purge path.

10. The system of claim 8, the controllable purge path comprising:
a controllable valve strategically disposed to reduce hydrogen embrittlement thereof.

11. The system of claim 10, wherein:
the controllable valve is a normally open solenoid valve.

12. The system of claim 10, further comprising:
a controller in signal communication with the controllable valve, the controller receptive of signals representing conditions corresponding to operation of the electrochemical cell and productive of a signal to control an operating condition of the controllable valve.

13. The system of claim 12, further comprising:
a pressure sensor for generating a signal representative of a pressure of gas within the separation chamber, the pressure sensor in signal communication with the controller.

14. The system of claim 12, further comprising:
a level sensor for generating a signal representative of a level of liquid within the separation chamber, the level sensor in signal communication with the controller.

15. The system of claim 8, wherein:
the electrochemical cell is an electrolysis cell.

16. The system of claim 8, wherein the plurality of conditions corresponding to operation of the electrochemical cell comprise at least two of:
a level of liquid within the separation chamber;
a maximum operating pressure of gas within the separation chamber;
an initiation of operation of the electrochemical cell; and
a conclusion of operation of the electrochemical cell.

17. The system of claim 16, further comprising:
a feed conduit in fluid communication between the electrochemical cell and the separation chamber; and
a pressure release in fluid communication with the feed conduit, the pressure release directly responsive to a release pressure within at least one of the separation chamber, the feed conduit, and the electrochemical cell to open, thereby reducing a pressure therein.

18. The system of claim 17, wherein:
the maximum operating pressure is less than the release pressure.

19. The system of claim 8, the controllable purge path comprising:
a flow rate control to control a flow rate therethrough of:
a liquid;
a gas; and
a mixture of the liquid and the gas.
